(19) United States
(12) Patent Application Publication
(10) Pub. No.: US 2007/0018934 A1
(43) Pub. Date: Jan. 25, 2007

(54) Liquid crystal display apparatus

(75) Inventors: Sung-soo Kim, Suwon-si (KR); Oh-jae Kwon, Anyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/484,763

(22) Filed: Jul. 12, 2006

(30) Foreign Application Priority Data
Jul. 22, 2005 (KR) 2005-0066853

(51) Int. Cl. G09G 3/36

(52) U.S. Cl. 345/98

(57) ABSTRACT

A liquid crystal display apparatus including a display panel includes a motion estimator for dividing a current frame into a plurality of blocks, each of the plurality of blocks having a predetermined size, comparing the plurality of blocks with a predetermined search region set for a next frame, and estimating a motion vector for the current frame based on a result of the comparison; a sub-frame constructor for constructing a first sub-frame and a second sub-frame for the current frame based on gray scale components of the current frame; a motion compensator for compensating a pixel display position of the second sub-frame using the motion vector; and a panel driver for displaying, the first sub-frame output from the sub-frame constructor and the compensated second sub-frame output from the motion compensator on the display panel sequentially. Thus, provided is a liquid crystal display apparatus, which is capable of minimizing a motion blur effect by compensating sub-frames in a pseudo-impulse type display control method using a motion vector that is estimated based on actual motion of a moving image.

### CROSS-REFERENCE TO RELATED APPLICATION

This application claims the benefit under 35 U.S.C. §119(a) of Korean Patent Application No. 2005-0066853, filed Jul. 22, 2005, in the Korean Intellectual Property Office, the entire disclosure of which is hereby incorporated by reference.

### BACKGROUND OF THE INVENTION

1. Field of the Invention

The present invention relates to a display apparatus. More particularly, the present invention relates to a liquid crystal display apparatus which is capable of minimizing a motion blur effect. The motion blur effect is minimized by compensating sub-frames in a pseudo-impulse type display control method using a motion vector that is estimated based on the actual motion of a moving image.

2. Description of the Related Art

In order to realize high image quality on a display apparatuses, particularly a liquid crystal display apparatus, the display apparatuses requires a high degree of visibility for moving pictures. When the moving pictures are displayed using a conventional liquid crystal display apparatus, a problem occurs in that motion of an object is displayed with the object appearing to be dragged. In other words, the object is displayed with a motion blur effect. This motion blur effect is attributed to a characteristic of the human eye in that the human eye tracks the motion of a moving object from one frame to the next as a sample and hold type. A liquid crystal display apparatus is a sample and hold type. Thus, the motion blur effect becomes more pronounced as the rate at which the object moves increases.

Conventional ways to overcome this problem include using liquid crystal displays having the characteristic of a fast response time and the characteristic of an improved intermediate gray scale response time. The improved intermediate gray scale response time is achieved by using an overdrive method that allows a target gray scale to be quickly reached.

However, the results achieved by using the overdrive method on a liquid crystal display apparatus falls short of achieving an acceptable degree of visibility of moving pictures that is equivalent to a degree of visibility of moving pictures on a cathode ray tube (CRT) display apparatus.

Therefore, in consideration that the motion blur effect that occurs on a liquid crystal display apparatus does not occur on a CRT display apparatus, an impulse type display control method has been applied to the liquid crystal display apparatus in a similar way as it is applied to a CRT display.

For the impulse type display control method, there is a method of dividing a frame of an input video signal into first and second sub-frames and then displaying the two sub-frames alternately. Hereinafter, such a method for reproducing a conventional impulse type display characteristic will be described with reference to FIG. 1 in the context of a still image.

In a display apparatus employing the above-mentioned conventional impulse type display control method, when a frame (a) of a still image is input, as shown in FIG. 1, first and second sub-frames (b) having respective gray scale components of the current frame (a) are constructed based on a predetermined gray scale component look up table (LUT) and are alternately displayed. According to such alternating display of the first and second sub-frames (b), a user views a display frame (c). Specifically, luminance L(100) of the display frame (c), which is represented by a combination of luminance L(0) corresponding to gray level 0 of the first sub-frame and luminance L(207) corresponding to gray level 207 of the second sub-frame, is equal to luminance L(100) corresponding to gray level 100 of the current frame (a). In addition, luminance L(210) of the display frame (c), which is represented by a combination of luminance L(33) corresponding to gray level 33 of the first sub-frame and luminance L(255) corresponding to gray level 255 of the second sub-frame, is equal to luminance L(210) corresponding to gray level 210 of the current frame (a). By displaying the video signal using the two sub-frames as described above, the conventional impulse type display control method may lessen the motion blur effect for a still image, as shown in FIG. 1.

However, this method has a limit as to the amount it can reduce the motion blur effect for a moving image. Now, an example of displaying a moving image in conventional impulse type display control method will be described with reference to FIG. 2.

As shown in FIG. 2, when a current frame (a) of a moving image and a next frame (a′) having motion information (\vec{V}ₐ) on the current frame (a) are input, as shown in FIG. 2, first and second sub-frames (b) having respective gray scale components of the current frame (a) are constructed based on a predetermined gray scale component LUT and are alternately displayed. At this time, a user follows the motion information (\vec{V}ₐ), consequently viewing a display frame (c′). Specifically, a combination of luminance L(0) corresponding to gray level 0 of the first sub-frame and luminance L(255) corresponding to gray level 255 of the second sub-frame represents luminance L(190) of the display frame (c′) rather than luminance L(100) of the next frame (a′) to be displayed. In addition, a combination of luminance L(33) corresponding to gray level 33 of the first sub-frame and luminance L(207) corresponding to gray level 207 of the second sub-frame represents luminance L(120) of the display frame (c′) rather than luminance L(210) of the next frame (a′) to be displayed. Therefore, while the conventional impulse type display control method performs adequately on a still image it does not reduce the motion blur effect for a moving image. Moreover, the motion blur effect becomes more pronounced as the rate of movement of the moving image increases.

Accordingly, there is a need for an improved display apparatus that ensures an acceptable degree of visibility for a display apparatus by minimizing a motion blur effect without deteriorating a display characteristic of the display apparatus.

### SUMMARY OF THE INVENTION

Exemplary embodiments of the present invention address at least the above problems and/or disadvantages and provide at least the advantages described below. Accordingly, an aspect of the present invention is to provide a liquid crystal display apparatus, which is capable of minimizing a motion blur effect by compensating sub-frames in a pseudo-impulse type display control method using a motion vector that is estimated based on actual motion of a moving image.

This aspect and other exemplary embodiments of the present invention are achieved by providing a liquid crystal display apparatus including a display panel, comprising: a motion estimator for dividing a current frame into a plurality of blocks, each of the plurality of blocks having a predetermined size, comparing the plurality of blocks with a predetermined search region set for a next frame, and estimating a motion vector for the current frame based on a result of the comparison; a sub-frame constructor for constructing a first sub-frame and a second sub-frame for the current frame based on gray scale components of the current frame; a motion compensator for compensating a pixel display position of the second sub-frame using the motion vector; and a panel driver for displaying the first sub-frame output from the sub-frame constructor and the compensated second sub-frame output from the motion compensator on the display panel sequentially.

According to an aspect of an exemplary embodiment of the present invention, the motion estimator calculates a plurality of motion prediction error values by applying a block matching algorithm to a current block of the plurality of blocks whose motion is to be estimated and the search region, and calculates the motion vector for the current block from a position having the minimum motion prediction error value of the calculated motion prediction error values.

According to an aspect of an exemplary embodiment of the present invention, the sub-frame constructor constructs to output the first sub-frame corresponding to a low gray scale component of the current frame and the second sub-frame corresponding to a high gray scale component of the current frame, based on a predetermined gray scale component look up table (LUT).

According to an aspect of an exemplary embodiment of the present invention, in the gray scale component look up table of the sub-frame constructor, luminance (L(fₙ)) according to a gray scale of the current frame (fₙ) is defined to be equal to a combination (L(fₙ₁)+L(fₙ₂)) of luminance (L(fₙ₁)) according to a gray scale of the first sub-frame frame (fₙ₁) and luminance (L(fₙ₂)) according to a gray scale of the second sub-frame (fₙ₂), while the first sub-frame frame (fₙ₁) and the second sub-frame (fₙ₂) are sequentially displayed by the panel driver.

According to an aspect of an exemplary embodiment of the present invention, the motion compensator compensates so as to output a pixel display position of the second sub-frame such that the second sub-frame is in between the first sub-frame and the next frame, based on the motion vector of the current frame output from the motion estimator.

According to an aspect of an exemplary embodiment of the present invention, the motion compensator compensates the second sub-frame (f′ₙ₂) output from the sub-frame constructor to be a compensated second sub-frame (f″ₙ₂), according to the following Equation:
f″ₙ₂(\vec{X})=f′ₙ₂(\vec{X}−α\vec{V})
where, represents a position of a pixel, represents the motion vector estimated in the motion estimator, and 0<α<1.

According to an aspect of an exemplary embodiment of the present invention, α is ½.

According to an aspect of an exemplary embodiment of the present invention, the panel driver displays the first sub-frame output from the sub-frame constructor and the compensated second sub-frame output from the motion compensator on the display panel sequentially by driving the current frame at a doubled rate.

According to an aspect of an exemplary embodiment of the present invention, the motion prediction error values are calculated by one of SAD (Sum of Absolute Difference) and MAD (Mean Absolute Difference).

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is an exemplary view showing a conventional gray scale representation of a frame of a still image and first and second sub-frames corresponding to the current frame;

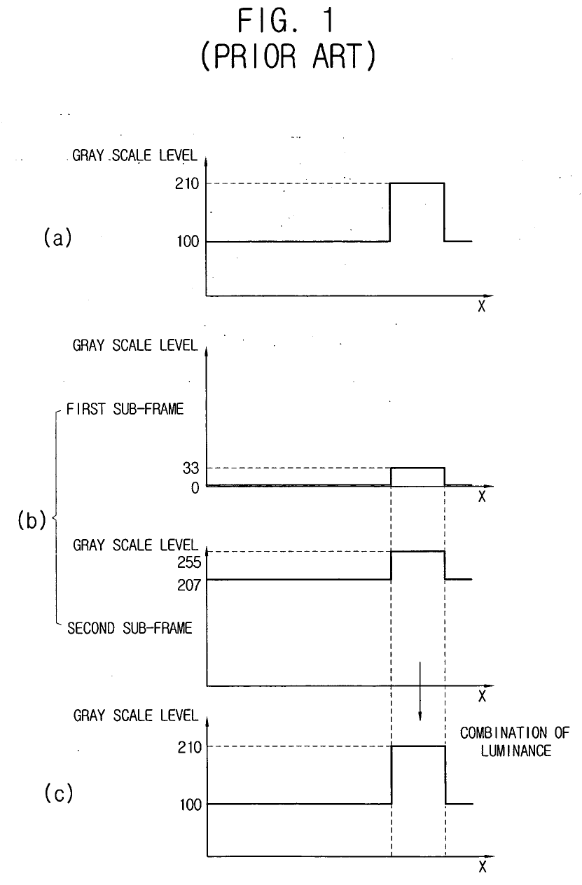

FIG. 2 is an exemplary view showing a conventional gray scale representation of current and next frames of a moving image and first and second sub-frames corresponding to the current frame;

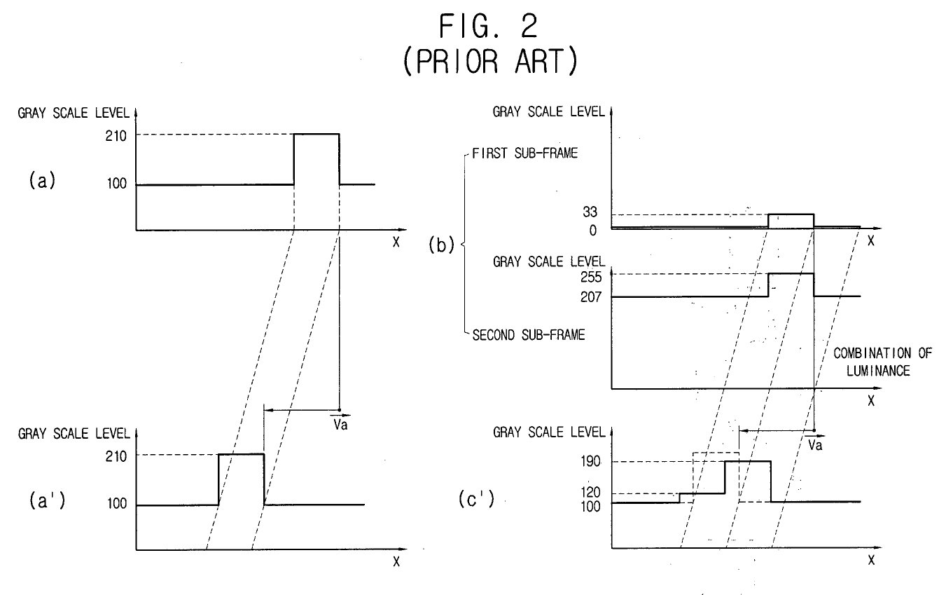

FIG. 3 is a control block diagram of a liquid crystal display apparatus according to an exemplary embodiment of the present invention;

FIG. 4 is an exemplary view illustrating an estimation of motion of an input image in a motion estimator;

FIG. 5 is an exemplary view of a gray scale component LUT used in a liquid crystal display apparatus according to an exemplary embodiment of the present invention; and

FIG. 6 is an exemplary view showing a gray scale representation of current and next frames of a moving image and first and second sub-frames corresponding to the current frame in a liquid crystal display apparatus according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

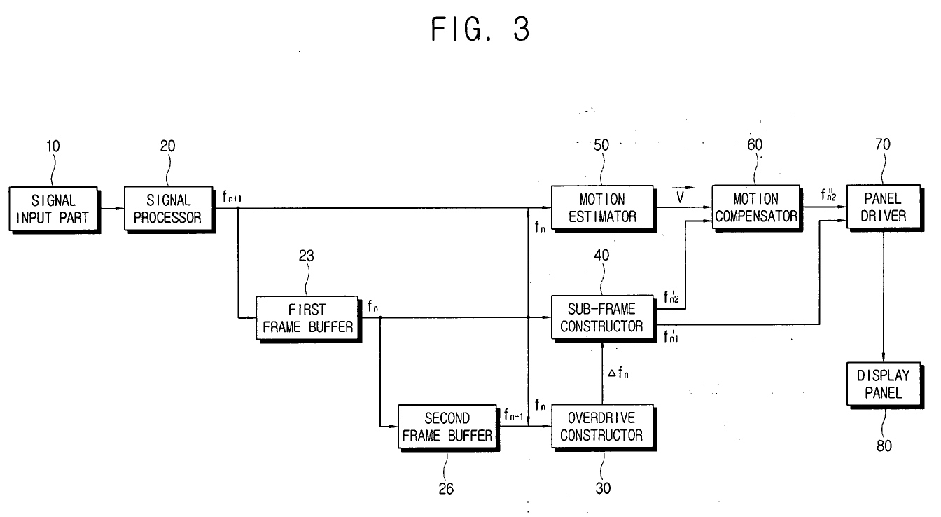

As shown in FIG. 3, a liquid crystal display apparatus according to an exemplary embodiment of the present invention includes a signal input part 10, a signal processor 20, a first frame buffer 23, a second frame buffer 26, an overdrive calculator 30, a sub-frame constructor 40, a motion estimator 50, a motion compensator 60, a panel driver 70, and a display panel 80.

The display panel 80 displays images under the control of the panel driver 70. The display panel 80 of an exemplary embodiment of the present invention is preferably a liquid crystal display (LCD) panel. Alternatively, the display panel 80 may be any type of display panels in which a motion blur effect occurs when displaying images. For example, display panel 80 may alternatively be a plasma display panel (PDP).

The signal processor 20 converts an input image signal into a signal having a format that can be processed by the panel driver 70. The signal processor 20 of an exemplary embodiment of the present invention may include a scaler for scaling the image signal and a signal converter for converting an input video signal into a signal that can be processed by the scaler. The signal converter may include an A/D converter, a video decoder, a tuner, and/or other components that correspond to image signals of a plurality of different formats input from the outside.

The first frame buffer 23 stores image data of a next frame fₙ₊₁ processed in and output from the signal processor 20, and outputs a current frame fₙ after delaying the next frame fₙ₊₁ by one frame. In addition, the second frame buffer 26 stores the image data of the next frame fₙ₊₁ processed in and output from the signal processor 20, and outputs a previous frame fₙ₋₁ after delaying the next frame fₙ₊₁ by two frames.

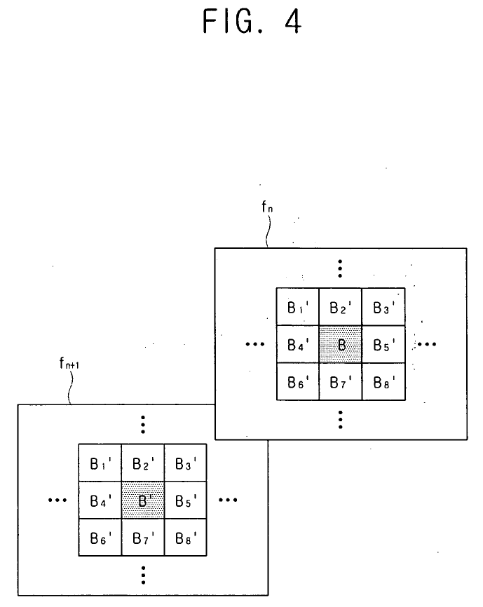

The motion estimator 50 divides the current frame fₙ input thereto into a plurality of blocks, each of which has a predetermined size. In addition, the motion estimator 50 estimates a motion vector \vec{V} for a block B (see FIG. 4) of the current frame fₙ (hereinafter referred to as the “current block”), whose motion is to be estimated. Here, it is to be understood that the motion estimator 50 may estimate a motion vector for blocks B1 to B8 (see FIG. 4) other than the current block B (hereinafter referred to as the “neighboring blocks”). Here, the motion estimator 50 estimates the motion vectors for compensating the motion of the blocks through a block matching algorithm (BMA). The Block matching algorithm compares two frames by a unit of block and estimates one temporary motion vector per block.

In other words, the motion estimator 50 divides the input current frame fₙ into blocks, each having a predetermined size, and estimates a motion vector for each block. Here, the motion estimator 50 compares the current block B of the plurality of blocks, whose motion vector is to be estimated, with a search region set for the next frame fₙ₋₁ (se FIG. 4), and calculates a plurality of motion prediction error values according to the following Equation 1.

$$E ( u , r ) = {\sum }_{( x , y ) ∈ B} \vert {f}_{n + 1} ( x + u , y + v ) - {f}_{n} ( x , y ) \vert \qquad [ Equation 1 ]$$

Where, (x, y) represents a coordinate of a pixel belonging to the current block B, and (u, v) represents a relative position apart from the current block B in a search region.

Here, information on the current frame fₙ is stored in the first frame buffer 23 and is provided to the motion estimator 50 when the current frame fₙ is compared with the next frame fₙ₊₁ in order to estimate the motion vector for the current frame fₙ.

It is to be understood that the plurality of motion prediction error values may be calculated using known techniques for estimating motion vectors, including a bidirectional block matching algorithm and a unidirectional block matching algorithm. In addition, the motion prediction error values may be calculated by any way of calculating motion prediction error values. Exemplary ways of calculating motion prediction error values comprise SAD (Sum of Absolute Difference), MAD (Mean Absolute Difference)and MSE (Mean Square Error). The SAD (Sum of Absolute Difference) is exemplified in an exemplary embodiment of the present invention.

On the other hand, the motion estimator 50 estimates the motion vector \vec{V} of the current block B from a position having the minimum motion prediction error value of the plurality of calculated motion prediction error values.

The overdrive calculator 30 is a functional part for causing the liquid crystals contained in the display panel 80 to reach a target gray scale quickly. The overdrive calculator 30 compares the current frame fₙ with the previous frame fₙ₋₁, assigns a pixel value larger than a current pixel value if a pixel value (gray level) of the current frame fₙ is shifted to a pixel value larger than a pixel value (gray level) corresponding to the previous frame fₙ₋₁, and assigns a pixel value smaller than the current pixel value if the pixel value (gray level) of the current frame fₙ is shifted to a pixel value smaller than the pixel value (gray level) corresponding to the previous frame fₙ₋₁. This may allow the liquid crystals of the display panel 80 to have a faster response.

In this case, the overdrive calculator 30 has a predetermined overdrive look up table. Based on the overdrive look up table, the overdrive calculator 30 obtains a pixel value difference Δfₙ to be added to or subtracted from the current frame fₙ based on a result of the comparison of the pixel value of the current frame fₙ with the pixel value of the previous frame fₙ₋₁, according to the following Equation 2.
Δfₙ=D(fₙ₋₁, fₙ) [Equation 2]
Here, information on the previous frame fₙ₋₁ is stored in the second frame buffer 26 and is provided to the overdrive calculator 30 when the current frame fₙ is compared with the previous frame fₙ₋₁ in order to calculate an overdrive pixel value difference for the current frame fₙ.

The sub-frame constructor 40 receives the current frame fₙ from the first frame buffer 23 and constructs a first sub-frame fₙ₁ corresponding to a low gray scale component of the current frame fₙ and a second sub-frame fₙ₂ corresponding to a high gray scale component of the current frame fₙ based on a predetermined gray scale component LUT.

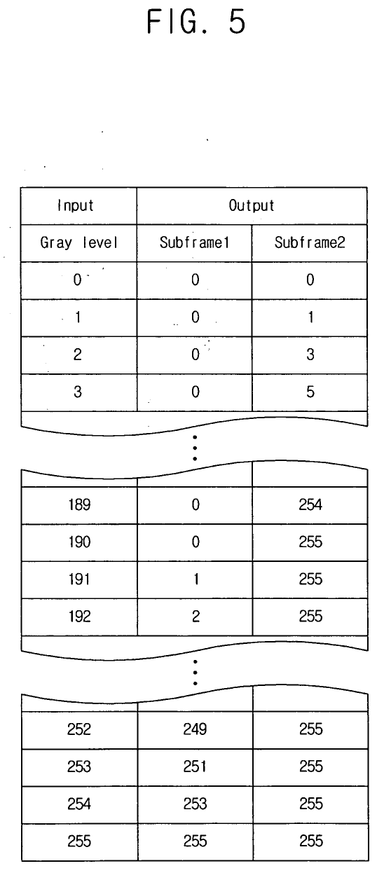

Here, as shown in FIG. 5, the gray scale component LUT contains information on a gray scale level of the first sub-frame corresponding to a low gray scale component of an input frame and information on a gray scale level of the second sub-frame corresponding to a high gray scale component of the input frame. Here, the gray scale component LUT in which the first sub-frame corresponds to the low gray scale component and the second sub-frame corresponds to the high gray scale component, as shown in FIG. 5, is used as only one example. It is to be understood that the first sub-frame may correspond to the high gray scale component and the second sub-frame may correspond to the low gray scale component. The gray scale component LUT as shown in FIG. 5 may be divided into a section where the low gray scale component is constant (0) and a section where the high gray scale component is constant (255). In addition, in the gray scale component LUT, it is preferable but not necessary, that luminance L(fₙ) according to the gray scale of the input current frame fₙ is defined to become equal to a combination L(fₙ₁)+L(fₙ₂) of luminance L(fₙ₁) according to the gray scale of the first sub-frame frame fₙ₁ and luminance L(fₙ₂) according to the gray scale of the second sub-frame fₙ₂, while the first sub-frame fₙ₁ and the second sub-frame fₙ₂ are sequentially displayed by the panel driver 70.

Here, the sub-frame constructor 40 adds the pixel value difference Δfₙ output from the overdrive calculator 30 to the first sub-frame fₙ₁ and second sub-frame fₙ₂ constructed corresponding to the current frame received from the first frame buffer 23 in order to improve a slow response time characteristic of the liquid crystals, consequently producing a modified first sub-frame f′ₙ₁ and a modified second sub-frame f′ₙ₂, as shown in the following Equation 3.
f′ₙ₁=fₙ₁+Δfₙ
f′ₙ₂=fₙ₂+Δfₙ [Equation 3]

The motion compensator 60 receives the modified second sub-frame f′ₙ₂ output from the sub-frame constructor 40 and compensates the received modified second sub-frame f′ₙ₂ using the motion vector \vec{V} output from the motion estimator 50.

At this time, the motion compensator 60 compensates the modified second sub-frame f′ₙ₂ output from the sub-frame constructor 40 according to the following Equation 4 and outputs a compensated second sub-frame f″ₙ₂ to the panel driver 70.
f″ₙ₂(\vec{X})=f′ₙ₂(\vec{X}−α) [Equation 4]
Where, \vec{X} represents a position of a pixel, \vec{V} represents the motion vector estimated in the motion estimator, and 0<α<1.

The panel driver 70 displays the modified first sub-frame f′ₙ₁ output from the sub-frame constructor 40 and the compensated second sub-frame f″ₙ₂ output from the motion compensator 60. At this time, the panel driver 70 displays an image as having the same speed as an original image by doubling the rate of the frame. For example, if an image signal input to the display apparatus has a frequency of 60 Hz, the panel driver 70 displays the frame on the display panel at 120 Hz.

Thereupon, since the second sub-frame of the current frame fₙ is located in between the first sub-frame of the current frame fₙ and the next frame fₙ₊₁, it is preferable, but not necessary, that α is ½ so as to apply ½ of a value of the motion vector \vec{V} when the motion compensator 60 compensates the modified sub-frame f′ₙ₂ to be the compensated second sub-frame f″ₙ₂ using Equation 4.

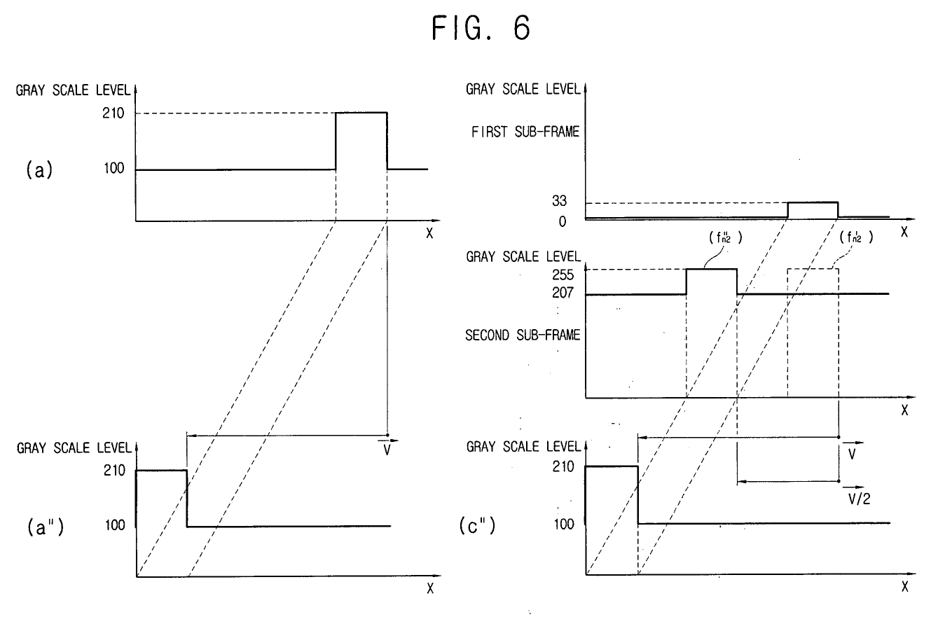

Hereinafter, an example of displaying a moving image in the liquid crystal display apparatus according to an exemplary embodiment of the present invention will be described with reference to FIG. 6. Here, an operation of the addition of the pixel value difference Δfₙ is omitted for the sake of brevity in explaining the compensation of the second sub-frame fₙ₂, which is a characteristic configuration of an exemplary embodiment of the present invention.

As shown in FIG. 6, when a current frame (a) of a moving image and a next frame (a″) having motion information (\vec{V}) on the current frame (a) are input, as shown in FIG. 6, the current frame (a) is divided into a first sub-frame f′ₙ₁ and a second sub-frame f′ₙ₂ based on the gray scale component LUT. At this time, the motion compensator 60 compensates pixel values of the second sub-frame f′ₙ₂ by ½ of the motion vector \vec{V} using Equation 4 and outputs the compensated second sub-frame f′ₙ₂. Then, the panel driver 70 displays the first sub-frame f′ₙ₁ and the compensated second sub-frame f″ₙ₂ on the display panel 80 sequentially at double the rate, instead of the current frame (a). At this time, a user follows the motion information \vec{V}, consequently viewing a display frame (c″). Specifically, luminance L(100) of the display frame (c″), which is represented by a combination of luminance L(0) corresponding to gray level 0 of the first sub-frame f′ₙ₁ and luminance L(207) corresponding to gray level 207 of the compensated second sub-frame f″ₙ₂, becomes equal to luminance L(100) corresponding to gray level 100 of the next frame (a″). In addition, luminance L(210) of the display frame (c″), which is represented by a combination of luminance L(33) corresponding to gray level 33 of the first sub-frame f′ₙ₁ and luminance L(255) corresponding to gray level 255 of the compensated second sub-frame f″ₙ₂, becomes equal to luminance L(210) corresponding to gray level 210 of the next frame (a″).

As shown in FIG. 6, in the liquid crystal display apparatus of an exemplary embodiment of the present invention, it can be seen that an effective difference of pixel values at a portion where an error occurs between a motion path and a pixel value lasting section is remarkably reduced by compensating the second sub-frame using the motion information \vec{V} between input frames when the first and second sub-frames corresponding to the input frames are displayed. Accordingly, in the liquid crystal display apparatus of an exemplary embodiment of the present invention, visibility of a moving image may be improved by reducing a motion blur effect of the moving image.

In the liquid crystal display apparatus of an exemplary embodiment of the present invention, there is provided as one example the configuration that the input frame is divided into the first and second sub-frames using the gray scale LUT shown in FIG. 5, the second sub-frame is compensated by ½ of the estimated motion vector \vec{V}, and the panel driver 70 displays the first sub-frame and the compensated second sub-frame sequentially at a double speed, instead of the input frame.

Alternatively, there may be provided another exemplary embodiment of a liquid crystal display apparatus wherein an input frame is divided into first to fourth sub-frames using a predetermined gray scale LUT, wherein the second sub-frame is compensated by ¼ of the estimated motion vector \vec{V}, the third sub-frame is compensated by 2/4 of the estimated motion vector \vec{V}, the fourth sub-frame is compensated by ¾ of the estimated motion vector \vec{V}, and the panel driver 70 displays the first sub-frame and the compensated second to fourth sub-frames sequentially at a quadrupled rate, instead of the input frame. Thereby, reducing the motion blur effect of the moving image. Of course, the use of two or four sub-frames in the exemplary embodiments described above is merely exemplary as any number of sub-frames can be utilized.

Accordingly, by compensating the sub-frames in a pseudo impulse type display control method using the motion vector estimated based on actual motion of the moving image, the liquid crystal display apparatus can minimize the motion blur effect and improve visibility of the moving image.

As apparent from the description, an exemplary embodiment of the present invention provides a liquid crystal display apparatus, which is capable of minimizing the motion blur effect and improves visibility of the moving image by compensating the sub-frame in a pseudo impulse type display control method using the motion vector that is estimation based on actual motion of the moving image.

While the invention has been shown and described with reference to certain embodiments thereof, it will be understood by those skilled in the art that various changes in form and details may be made therein without departing from the spirit and scope of the invention as defined by the appended claims.

What is claimed is:

1. A liquid crystal display apparatus including a display panel, comprising:
a motion estimator for dividing a current frame into a plurality of blocks, each of the plurality of blocks having a predetermined size, comparing the plurality of blocks with a predetermined search region set for a next frame, and estimating a motion vector for the current frame based on a result of the comparison;
a sub-frame constructor for constructing a first sub-frame and a second sub-frame for the current frame based on gray scale components of the current frame;
a motion compensator for compensating a pixel display position of the second sub-frame using the motion vector; and
a panel driver for displaying the first sub-frame output from the sub-frame constructor and the compensated second sub-frame output from the motion compensator on the display panel sequentially.

2. The liquid crystal display apparatus according to claim 1, wherein the motion estimator calculates a plurality of motion prediction error values by applying a block matching algorithm to a current block of the plurality of blocks whose motion is to be estimated and the search region, and calculates the motion vector for the current block from a position having the minimum motion prediction error value of the calculated motion prediction error values.

3. The liquid crystal display apparatus according to claim 2, wherein the sub-frame constructor constructs to output the first sub-frame corresponding to a low gray scale component of the current frame and the second sub-frame corresponding to a high gray scale component of the current frame, based on a predetermined gray scale component look up table (LUT).

4. The liquid crystal display apparatus according to claim 3, wherein in the gray scale component look up table of the sub-frame constructor, luminance (L(fₙ)) according to a gray scale of the current frame (fₙ) is defined to be equal to a combination (L(fₙ₁)+L(fₙ₂)) of luminance (L(fₙ₁)) according to a gray scale of the first sub-frame frame (fₙ₁) and luminance (L(fₙ₂)) according to a gray scale of the second sub-frame (fₙ₂), while the first sub-frame frame (fₙ₁)and the second sub-frame (fₙ₂) are sequentially displayed by the panel driver.

5. The liquid crystal display apparatus according to claim 4, wherein the motion compensator compensates so as to output a pixel display position of the second sub-frame such that the second sub-frame is in between the first sub-frame and the next frame, based on the motion vector of the current frame output from the motion estimator.

6. The liquid crystal display apparatus according to claim 5, wherein the motion compensator compensates the second sub-frame (f′ₙ₂) output from the sub-frame constructor to be a compensated second sub-frame (f″ₙ₂), according to the following Equation:
f″ₙ₂(\vec{X})−f″ₙ₂(\vec{X}−α\vec{V})
where, \vec{X} represents a position of a pixel, \vec{V} represents the motion vector estimated in the motion estimator, and 0<α<1.

7. The liquid crystal display apparatus according to claim 6, wherein α is ½.

8. The liquid crystal display apparatus according to claim 6, wherein the panel driver displays the first sub-frame output from the sub-frame constructor and the compensated second sub-frame output from the motion compensator on the display panel sequentially by driving the current frame at a doubled rate.

9. The liquid crystal display apparatus according to claim 8, wherein the motion prediction error values are calculated by one of SAD (Sum of Absolute Difference) and MAD (Mean Absolute Difference).

10. The liquid crystal display apparatus according to claim 1, wherein the motion compensator compensates so as to output a pixel display position of the second sub-frame such that the second sub-frame is in between the first sub-frame and the next frame, based on the motion vector of the current frame output from the motion estimator.

11. The liquid crystal display apparatus according to claim 10, wherein the motion compensator compensates the second sub-frame (f′ₙ₂) output from the sub-frame constructor to be a compensated second sub-frame (f″ₙ₂), according to the following Equation:
f″ₙ₂(\vec{X})−f′ₙ₂(\vec{X}−α\vec{V})
where, \vec{X} represents a position of a pixel, \vec{V} represents the motion vector estimated in the motion estimator, and 0<α<1.

12. The liquid crystal display apparatus according to claim 11, wherein α is ½.

13. The liquid crystal display apparatus according to claim 11, wherein the panel driver displays the first sub-frame output from the sub-frame constructor and the compensated second sub-frame-output from the motion compensator on the display panel sequentially by driving the current frame at a doubled rate.

14. The liquid crystal display apparatus according to claim 13, wherein the motion prediction error values are calculated by one of SAD (Sum of Absolute Difference) and MAD (Mean Absolute Difference).
